(19) United States
(12) Patent Application Publication
(10) Pub. No.: US 2017/0334742 A1
(43) Pub. Date: Nov. 23, 2017

(54) MORINGA OLEIFERA AUGMENTED FILTER MEDIA

(71) Applicant: EverWaters LLC

(72) Inventors: Matthew Lisle, Bryn Mawr, PA (US); Adrian A Lievano, Miami, FL (US)

(21) Appl. No.: 15/332,691

(22) Filed: Oct. 24, 2016

Related U.S. Application Data
(60) Provisional application No. 62/338,011, filed on May 18, 2016.

(51) Int. Cl. C02F 1/28; C02F 1/50; B01D 39/16; B01D 39/20; C02F 1/00

(52) U.S. Cl. CPC C02F 1/288; B01D 39/2058; B01D 39/2062; B01D 39/2072; C02F 1/286; C02F 1/283; C02F 1/001; B01D 39/1653; C02F 1/50; B01D 2239/0442; B01D 2239/0485; C02F 2303/04; C02F 2303/20; B01D 2239/10

(57) ABSTRACT

The present disclosure describes an augmented medium for water purification including a medium that is treated with Moringa oleifera coagulant protein (MOCP), as well as uses and methods of making the same. The present disclosure also describes water filters including such augmented medium, as well as methods of purifying water by using such filters.

### CROSS REFERENCES TO RELATED APPLICATIONS

The present application claims priority under 35 U.S.C. §119(e) to U.S. Provisional Patent Application Nos. 62/338,011, filed on May 18, 2016, which is incorporated herein by reference in its entirety.

### FIELD OF INVENTION

The invention relates to Moringa oleifera coagulant protein (MOCP) water filters and methods of making and using the same.

### BACKGROUND OF THE INVENTION

Water is essential for life on earth. It constitutes approximately 60% of an average adults' body weight. It is recommended that, on average, men consume 2.5 liters and women 2 liters of water per day from drinks and food sources.

Safe and readily available drinking water is critical for public health. However, hundreds of millions of people still do not have ready access to clean and safe drinking water. It is estimated that about 842,000 people die each year from diarrhea because they consume unsafe drinking-water. And nearly 2.2 million children die annually from illnesses related to contaminated water.

Water can be purified and thus made drinkable by the use of water filters, which use physical barriers or chemical or biological processes to remove contaminants and impurities.

Many of the water filters in use today are either too costly for use in those areas where drinking water is scarce, too cumbersome to use, or too inefficient, at least with respect to some types of contaminants.

Thus, there remains a need for water filters that are less costly, easier to use and/or more efficient in terms of contaminant removal. The present invention addresses this need.

### SUMMARY OF THE INVENTION

The present invention provides an augmented medium for water purification, including a medium selected from the group consisting of ceramic, granular activated carbon, resin, and carbon blocks, or a combination thereof; and purified Moringa oleifera coagulant protein (MOCP).

In some embodiments, the Moringa oleifera coagulant protein is adsorbed to the medium.

In some embodiments, the medium is ceramic.

In some embodiments, the medium is granular activated carbon.

In some embodiments, the medium is resin.

In some embodiments, the medium is carbon blocks.

In some embodiments, Moringa oleifera coagulant protein is adsorbed to the surface of the medium.

In some embodiments, the augmented medium for water purification consists essentially of a medium selected from the group consisting of ceramic, granular activated carbon, resin, and carbon blocks, or a combination thereof; and purified Moringa oleifera coagulant protein.

In some embodiments, the purified Moringa oleifera coagulant protein is prepared by a process including steps of (1) treating a Moringa oleifera seed press cake to obtain an evenly divided granular powder, (2) adding the granular powder to an aqueous salt solution or water, thereby eluting Moringa oleifera coagulant protein out of the powder, and (3) purifying the Moringa oleifera coagulant protein obtained in step 2 by one or a combination of dialysis, delipidation, centrifugation and ion exchange chromatography.

In some embodiments, the purified Moringa oleifera coagulant protein is bound to the medium by a process including steps of (1) obtaining the Moringa oleifera coagulant protein purified by one or a combination of dialysis, dilapidation, centrifugation and ion exchange chromatography, (2) creating an aqueous solution of the protein of the preceding step, and (3) treating the medium with the aqueous solution.

In some embodiments, the carbon medium is activated by physical activation or by chemical activation.

In some embodiments, the aqueous solution with which the medium is treated is substantially free of proteins other than Moringa oleifera coagulant protein.

In some embodiments, the aqueous solution with which the medium is treated is substantially free of lipids, carbohydrates, nucleic acids, and proteins other than Moringa oleifera coagulant protein.

In some embodiments, the aqueous solution with which the medium is treated is substantially free of organic molecules other than Moringa oleifera coagulant protein.

In some embodiments, the augmented medium is configured to inhibit growth of microorganisms on the media surfaces.

In some embodiments, the augmented medium is configured to reduce the biochemical oxygen demand of water purified by the augmented medium by comparison to the biochemical oxygen demand of unpurified water.

In some embodiments, the biochemical oxygen demand is reduced by about 100%.

The present invention provides a method of making an augmented medium for water purification, including steps of (1) treating a Moringa oleifera seed press cake to obtain an evenly divided granular powder, (2) adding the granular powder to an aqueous salt solution or water, thereby eluting Moringa oleifera coagulant protein (MOCP) out of the powder, (3) purifying the Moringa oleifera coagulant protein obtained in step 2 by one or a combination of dialysis, dilapidation, centrifugation and ion exchange chromatography, (4) creating an aqueous solution of the Moringa oleifera coagulant protein of the preceding step, and (4) treating the medium with the aqueous solution, wherein the purified Moringa oleifera coagulant protein is adsorbed to the medium.

In some embodiments, the medium is selected from the group consisting of ceramic, granular activated carbon, resin, and carbon blocks.

In some embodiments, the medium is carbon that is activated by physical activation or by chemical activation.

The present invention provides a water filter, including the augmented medium for water purification disclosed herein.

In some embodiments, the water filter is configured to be gravity-fed.

In some embodiments, the water filter includes at least an upper chamber and a lower chamber separated by at least one filter, wherein said filter is positioned to filter water as it passes from said upper chamber to said lower chamber, and wherein the filter comprises the augmented medium for water purification of claim 1.

The present invention provides a water filtration device, including at least an upper chamber and a lower chamber separated by at least one filter, wherein said filter is positioned to filter water as it passes from said upper chamber to said lower, and wherein the filter comprises means for purifying the water and means for substantially inhibiting bacterial growth.

The present invention provides a method of purifying water, including treating water with the water filter disclosed herein.

The present invention provides a method of inactivating bacteria in water, including treating water with the water filter disclosed herein.

### BRIEF DESCRIPTION OF THE DRAWING

FIG. 1 shows the fundamental difference between non-coated activated carbon (FIG. 1A) and activated carbon coated with Moringa oleifera coagulant protein (MOCP) (FIG. 1B). FIG. 1A shows activated carbon not coated with MOCP on which microorganisms and biofilms can grow. FIG. 1B shows activated carbon coated with MOCP on which microorganisms are killed on contact and growth of biofilms is inhibited.

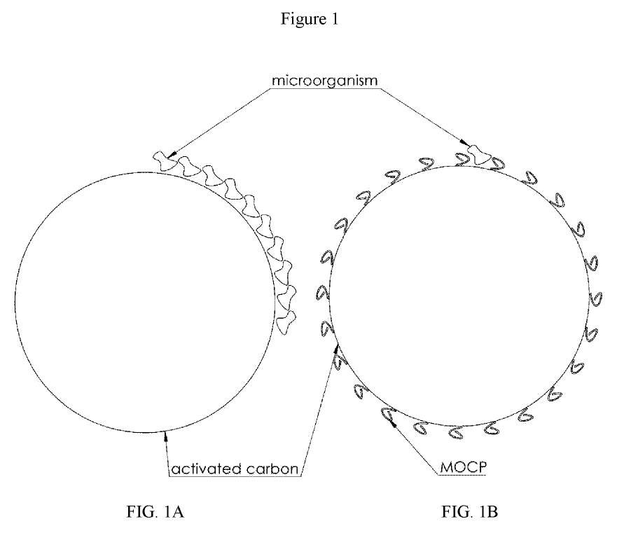

FIG. 2 shows an embodiment in which a ceramic filter is treated with MOCP. The MOCP-treatment prevents growth of biofilms and deactivates microbes in the same way as illustrated in FIG. 1.

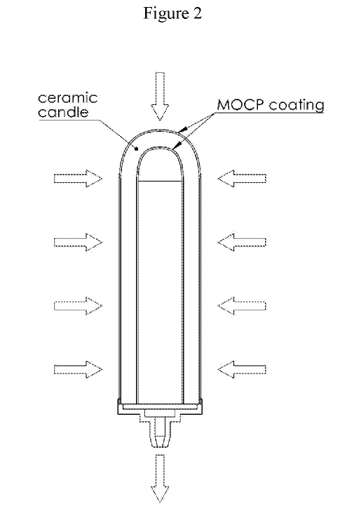

FIG. 3 shows an embodiment in which a ceramic filter medium is treated with MOCP (FIG. 3A) and a carbon filter medium is coated with MOCP (FIG. 3B) in point-of-use household water filters. The broken lines in the drawings indicate MOCP-treatment.

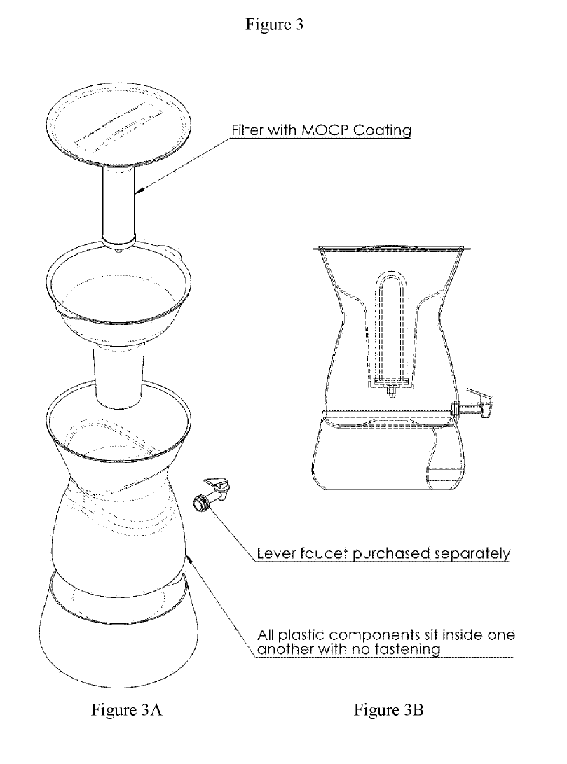

FIG. 4 shows an embodiment in which an activated carbon block is coated with MOCP. MOCP is coated onto the carbon block at a temperature that does not denature the protein after the carbon block has undergone a firing process. The MOCP-treatment covers all exposed surfaces of the carbon block.

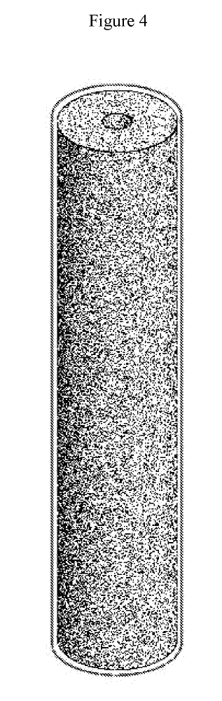

FIG. 5 shows an exemplary process of the present invention wherein a ceramic filter element is coated with MOCP. A carbon block may be coated by the same process. The process is conducted at ambient temperature (approximately room temperature). The filter element is moved through a container filled with a solution including MOCP to obtain coating. Preferably, the ceramic filter element is fully submerged and rotated during the coating process so that coating is achieved equally on all sides. The flow (laminar, turbulent or both) is preferably adjusted to obtain optimal coating. The coated ceramic filter element may comprise an internal void and be complemented with internal filter media.

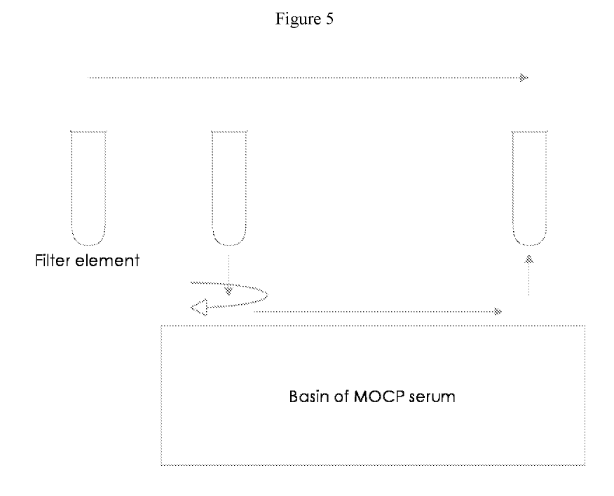

FIG. 6 shows an embodiment wherein a MOCP-treated carbon block is used to purify water dispensed by a refrigerator. The MOCP-treated carbon block fits into a refrigerator or other carbon block housing in the same way as a non-MOCP-treated carbon block. However, the MOCP-activated carbon block has a resistance to biofilm growth that the non-MOCP-treated carbon block does not have.

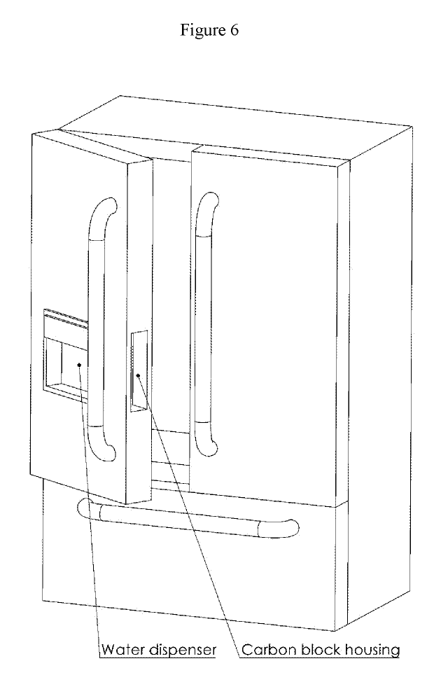

FIG. 7 shows an embodiment wherein MOCP is purified from Moringa oleifera seed cake prior to adsorption onto a suitable filter media.

FIG. 8 shows embodiments wherein MOCP-treated filter media may be combined with other types of filter media not coated with MOCP. FIG. 8A shows a carbon block that has cavities in which MOCP-treated resin or MOCP-treated granular activated carbon may be filled. FIG. 8B shows a ceramic filter that has an internal cavity (coated or not coated with MOCP) in which MOCP-treated resin, MOCP-treated granular activated carbon, granular activated carbon, another MOCP-coated material, or a combination thereof, may be filled.

### DETAILED DESCRIPTION OF THE INVENTION

### Water Purification Medium

The present invention generally relates to the augmentation of filter media with a purified cationic protein found in the seed of Moringa oleifera and known as Moringa oleifera coagulant protein (MOCP), and its use for water purification. The term Moringa oleifera coagulant protein (MOCP) as used herein refers to all cationic proteins found in Moringa oleifera seed, some of which may have different molecular weights.

The present invention provides an augmented medium for water purification including a medium and purified Moringa oleifera coagulant protein (MOCP). In some embodiments, the medium is ceramic, granular activated carbon, resin or carbon blocks, or a combination thereof.

In some embodiments, the augmented medium for water purification consists essentially of a medium selected from the group consisting of ceramic, granular activated carbon, resin, and carbon blocks; and purified Moringa oleifera coagulant protein, preferably located on the surface of the medium.

The present invention provides a method of making an augmented medium for water purification wherein, in some embodiments, the medium is selected from the group consisting of ceramic, granular activated carbon, resin, and carbon blocks.

Moringa oleifera is a tropical tree of the genus Moringa, which is the only genus of the family Moringaceae. Moringa oleifera is cultivated because of its medicinal and nutritional value.

Moringa oleifera is native to the western and sub-Himalayan tracts, India, Pakistan, Asia Minor, Africa, and many other countries. It is a cosmopolitan, drought tolerant tree available throughout the year and cultivated across the tropical belt for many different purposes.

The seeds ofMoringa oleifera are primarily utilized to obtain oil that is often commercialized as a food supplement or as a component of cosmetics. The residue from the process of extracting this oil, also called the press cake or seed cake, contains water soluble, low molecular weight proteins, which can act as primary coagulants in contaminated water and wastewater treatment. Kansal & Kumari, Chemical Reviews 114:4993-5010 (2014).

Moringa oleifera coagulant protein (MOCP) is characterized by an overall positive charge. MOCP is thought to have a molecular weight of 6-16 kDa with an isoelectric point above 10. In addition to its cationic nature, MOCP has been reported to display alternating hydrophilic and hydrophobic motifs. Shebek et al., Langmuir 31:4496-4502 (2015). MOCP has been documented to have strong heat-resistant properties. Whereas most proteins break down at boiling temperature, MOCP has been demonstrated to be able to withstand these temperatures. Ghebremichael et al., Water Research 39:2338-2344 (2005). MOCP is considered to belong to a broader class of proteins, known as host defense peptides, or antimicrobial peptides.

MOCP not functionalized on the surface of any filter media has been reported as being effective in the removal of certain algae (e.g., Chlorella, Microcystis, Oocystis and Scenedesmus) by flocculation. Barrado-Moreno et al., Toxicon 110:68-73 (2015). MOCP has also been reported to cause destabilization and sedimentation of colloidal particles. Kansal & Kumari, Chemical Reviews 114:4993-5010 (2014). The mechanism by which MOCP induces coagulation has been described as adsorption and neutralization of charges and inter-particle bridging. The zeta potential of a typical MOCP solution is reportedly positive, and the zeta potential of synthetic water is negative; hence, the MOCP destabilizes negatively charged colloids. Kansal & Kumari, Chemical Reviews 114:4993-5010 (2014); Jerri et al., Langmuir 28:2262-2268 (2011).

MOCP treats water by acting both as a coagulant and as an antimicrobial agent. MOCP damages the cell wall of bacteria via membrane fusion and kills the bacteria. Shebek et al., Langmuir 31:4496-4502 (2015); Jerri et al., Langmuir 28:2262-2268 (2011). MOCP induces bacterial cell death by interfering with the bacterial cell membrane.

The initial interaction between MOCP and the bacterial cell membrane is facilitated by the protein's net positive charge. And MOCP's amphiphilic helix-loop-helix motif then facilitates the proteins incorporation into bacterial membranes.

MOCP is able to target and kill many microbes, most notably microbes found in contaminated water that are considered harmful to human health. MOCP has been noted to bind more favorably to anionic lipids, and through the process of membrane fusion, it is able to deactivate negatively charged microbes. Shebek et al., Langmuir 31:4496-4502 (2015). MOCP not functionalized on the surface of any filter media, has been reported to remove streptococci, clostridium, E. coli, Helminth eggs and other heterophobic bacteria. Kansal & Kumari, Chemical Reviews 114:4993-5010 (2014).

A variety of media for water purification and filtration are known in the art, non-limiting examples of which include granular activated carbon, carbon blocks, ceramic and resin.

Activated carbon is a form of carbon treated by heat or otherwise to have small pores and increased adsorptive power. These pores increase the surface area of the carbon, thus increasing the surface area available for adsorption by the carbon or chemical reactions on the carbon. Activated carbon has many industrial applications known in the art. See, e.g., U.S. Pat. No. 5,198,004, which is incorporated herein by reference in its entirety. Granular activated carbon is characterized by a relatively larger particle size compared to powdered activated carbon. Granular activated carbon is known in the art to be useful for water purification because it has the ability to adsorb a variety of water impurities. See, e.g., U.S. Pat. No. 4,261,805, which is incorporated herein by reference in its entirety. Activated carbon, including granular activated carbon, is commercially available from many sources, including from Cabot Corporation, GA, and from Calgon Carbon Corporation, PA. Granular activated carbon can be surface-modified with a variety of art-known compounds and materials to enhance its capacity for adsorption, according to methods generally known in the art. See, e.g., Chen et al., Carbon 41:1979-1986 (2003).

Carbon blocks may be made by compressing powdered carbon into particular shapes useful for the desired application. The desired pore size and other characteristics of the carbon blocks are achieved by the selection of proper compression parameters, which are selected according to principles generally known in the art.

Carbon blocks are known in the art to be useful for water purification because of their ability to adsorb a variety of water impurities. See, e.g., U..S. Pat. No. 6,368,504, which is incorporated herein by reference in its entirety. Carbon blocks are commercially available from many sources, including from CBTech, NV.

The term ceramic is usually understood to refer to any product (as earthenware, porcelain, or brick) made essentially from a nonmetallic mineral (e.g., as clay) by firing at a high temperature. Ceramics have many industrial applications known in the art, e.g., as semiconductors and in bullet-proof vests. Ceramic water filters are known in the art. See, e.g., Plappally et al., Health Behaviour & Public Health 1:1-14 (2011).

Resin is commonly understood in the art to be a highly viscous substance, or combination of substances, not soluble in water. Resins for use in water filtration are generally known in the art, and may be purchased from a variety of art-known commercial sources, including ResinTech Inc., NJ. Preferably, the resin is in the form of micro-sized beads.

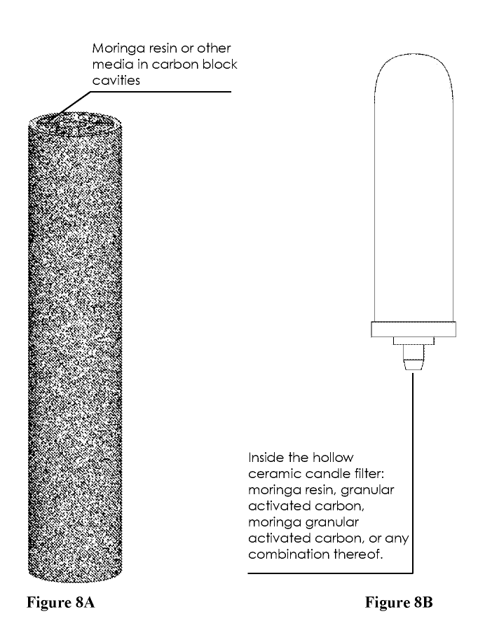

In some embodiments, the filter medium treated with purified MOCP is inserted into or mixed with untreated medium, for example ceramic, granular activated carbon or carbon blocks. In some embodiments, filter medium that has not been treated with purified MOCP is inserted into or mixed with medium that has been treated with purified MOCP, for example ceramic, granular activated carbon or carbon blocks. See for example FIG. 8 as a non-limiting illustration of these embodiments.

Preparation and Purification of Moringa oleifera Coagulant Protein (MOCP)

The present invention provides an augmented medium for water purification wherein the purified Moringa oleifera coagulant protein is prepared by a process including steps of (1) treating a Moringa oleifera seed press cake to obtain an evenly divided granular powder, (2) adding the granular powder to an aqueous salt solution or water, thereby eluting protein out of the powder, and (3) purifying the protein obtained in step 2 by one or a combination of dialysis, delipidation, centrifugation and ion exchange chromatography.

The present invention provides a method of making an augmented medium for water purification, including steps of (1) treating a Moringa oleifera seed press cake to obtain an evenly divided granular powder, (2) adding the granular powder to an aqueous salt solution or water, thereby eluting Moringa oleifera coagulant protein (MOCP) out of the powder, (3) purifying the Moringa oleifera coagulant protein (MOCP) obtained in step 2 by one or a combination of dialysis, delipidation, centrifugation and ion exchange chromatography.

To obtain MOCP, there are, according to some embodiments, specific steps to maximize the amount of protein obtained via extraction. The seeds are first harvested from the Moringa oleifera tree, and the oil is extracted from the seeds using either a physical press or a chemical solution, in accordance with methods generally known in the art. The resulting seedcake is then ground, via a hopper, and reduced into a powder.

Processes for obtaining a crude extract from Moringa oleifera seeds are generally known in the art. Non-limiting examples of processes for obtaining a crude extract from Moringa oleifera seeds are provided in Kansal & Kumari, Chemical Reviews 114:4993-5010 (2014), and U.S. Pat. No. 6,500,470, which are incorporated herein by reference in their entireties.

In some embodiments of the present invention, the extraction process includes (1) treating a Moringa oleifera seed press cake to obtain an evenly divided granular powder, (2) adding the granular powder to an aqueous solution of sodium chloride or distilled water in order to leach protein out of the powder, and (3) using any or multiple of the following processes as a tertiary step: dialysis, delipidation, centrifugation and ion exchange.

A concentrated salt solution may be used to elute the protein from the seed cake. Kansal & Kumari, Chemical Reviews 114:4993-5010 (2014); and Ghebremichael et al., Appl. Microbiol. Biotechnol. 70:526-532 (2006), which are incorporated herein by reference in their entireties.

The present invention provides an augmented medium for water purification wherein the purified Moringa oleifera coagulant protein is purified by one or a combination of dialysis, delipidation, centrifugation and ion exchange chromatography

The present invention provides a method of making an augmented medium for water purification including the steps of purifying the Moringa oleifera coagulant protein (MOCP) by one or a combination of dialysis, delipidation, centrifugation and ion exchange chromatography.

Processes for purifying proteins in general are known in the art. See, e.g., Protein Purification-Principles, High Resolution methods, and Applications Vol. 54, J.-C. Janson ed., Wiley (2011), which is incorporated herein by reference in its entirety.

Using dialysis for purifying proteins is generally known in the art. See, e.g., Short Protocols in Molecular Biology, 3^{rd} Edition, F. Ausubel et al., eds., Wiley (1995), which is incorporated herein by reference in its entirety. A non-limiting example of this protein purification approach is provided in U.S. Pat. No. 7,544,354, which is incorporated herein by reference in its entirety.

The term delipidation refers to the process of removing lipids or lipid groups, often from a protein, which is generally known in the art. See, e.g., A Practical Guide to Membrane Protein Purification, von Jagow & Schagger, eds., Academic Press (1994), which is incorporated herein by reference in its entirety. A non-limiting example of this protein purification approach is provided in U.S. Pat. No. 7,943,046, which is incorporated herein by reference in its entirety.

Centrifugation is a process in which centripetal force is applied for the differential sedimentation of a heterogeneous mixture of different compounds, e.g., proteins. This process is widely used in industry and research for the purpose of purifying proteins and otherwise, and thus widely known in the art. See, e.g., Short Protocols in Molecular Biology, 3^{rd} Edition, F. Ausubel et al., eds., Wiley (1995).

Chromatography is a process in which a mixture of different compounds, e.g., proteins, is separated based on the compounds' different rates of migration through a medium. Ion exchange chromatography is a specific type of chromatography where the different compounds are separated based on their respective charges. Use of chromatography in general and ion exchange chromatography in particular for the purpose of protein purification are widely known in the art. See, e.g., Short Protocols in Molecular Biology, 3^{rd} Edition, F. Ausubel et al., eds., Wiley (1995). A non-limiting example of this protein purification approach is provided in U.S. Pat. No. 5,451,662, which is incorporated herein by reference in its entirety.

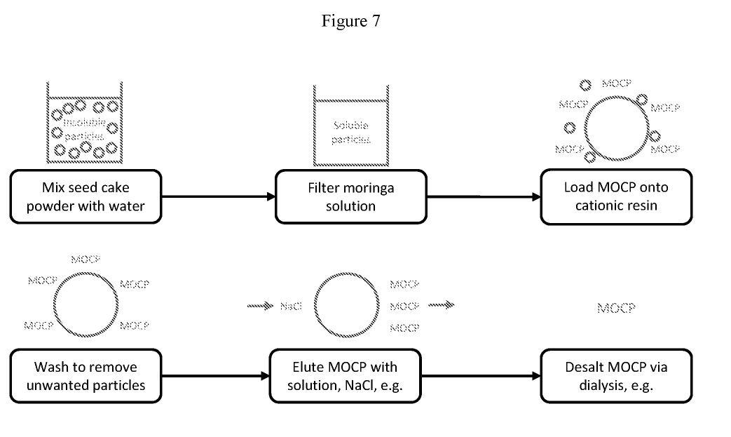

In some embodiments of the present invention, MOCP is purified from Moringa oleifera seeds as described in FIG. 7.

Non-limiting examples of ion-exchange chromatographic purification of MOCP are provided in Ghebremichael et al., Appl. Microbiol. Biotechnol. 70:526-532 (2006), which is incorporated herein by reference in its entirety.

### Activation of Carbon Medium

In some embodiments of the present invention, the carbon medium of the augmented medium for water purification is activated by physical activation or by chemical activation.

In some embodiments of the present invention, the method of making an augmented medium for water purification includes that the carbon medium is activated by physical activation or by chemical activation.

Sources from which carbon suitable for use in the present invention is derived include animal materials, such as bone for example, and plant matter, such as wood and coconut shells for example. Activated carbon is also produced from coal. If coal is to be activated in a thermal process to produce granular carbon, the coal may be exposed to an oxidizing gas, such as steam, air or carbon dioxide. The oxidizing gas, or a combination of different oxidizing gases, reacts with the coal and causes an increase in the coal's pore volume and surface area. The desirable properties of activated carbon stem from the increase in pore volume and surface area. See U.S. Pat. No. 4,107,084, which is incorporated herein by reference in its entirety.

Processes for activating carbon media by physical or chemical means are known in the art, and disclosed for example in U.S. Pat. No. 4,107,084, as well the patents referenced therein.

In some embodiments, carbon is subjected to physical activation, which may include heating it at a high temperature (e.g., 800° C.) in a carbon gasification reaction (H₂O and/or CO₂, for example). See, e.g., U.S. Pat. No. 8,252,716, which is incorporated herein by reference in its entirety. Optionally, this process may include the use of a catalyst for gasification (e.g., potassium and sodium salts).

In some embodiments of the present invention, carbon is subjected to chemical activation, which preferentially includes heating at a temperature that is lower than the temperature customarily used for physical activation of carbon (e.g., 500° C.) and using a chemical additive. See, e.g., U.S. Pat. Nos. 8,252,716 and 9,018,131, which are incorporated herein by reference in their entireties.

Preparation of Moringa oleifera-Treated/Functionalized Carbon Medium

The present invention provides an augmented medium for water purification prepared by creating an aqueous solution of purified MOCP and treating the medium with the aqueous solution, wherein the purified MOCP is adsorbed to the medium.

The present invention provides a method of making an augmented medium for water purification, including steps of (1) obtaining the protein purified by one or a combination of dialysis, delipidation, centrifugation and ion exchange chromatography, (2) creating an aqueous solution of the protein (MOCP) of the preceding step, and (3) treating the medium with the aqueous solution, wherein the purified MOCP is adsorbed to the medium.

In some embodiments of the present invention, the aqueous solution with which the medium is treated is substantially free of proteins other than MOCP, lipids, carbohydrates, nucleic acids, or organic molecules other than MOCP, or a combination thereof.

Methods for analyzing the purity of protein solutions are generally known in the art. A non-limiting example of a method that may be used for that purpose is mass spectrometry, possibly in combination with other analytic methods such as gas chromatography or liquid chromatography. See, e.g., Chhabil Dass, Principles and Practice of Biological Mass Spectrometry, 8th Edition, John Wiley & Sons, Inc. (2001), which is incorporated herein by reference in its entirety.

In some embodiments, the augmented medium is configured to inhibit growth of microorganisms on the surface of the medium.

In some embodiments, the augmented medium is configured to inhibit growth of microorganisms on the surface of the medium by about 10%, 20%, 30%, 40%, 50%, 60%, 70%, 80%, 90% or 100% by comparison to the growth of microorganisms on medium not augmented with MOCP.

In some embodiments of the present invention the augmented medium is configured to inhibit growth of microorganisms on the surface of the medium by about 10 to 30%, 30 to 50%, 50 to 70%, or 70 to 100% by comparison to the growth of microorganisms on medium not augmented with MOCP.

Assays to measure growth of microorganisms, and inhibition thereof, on a medium, including augmented medium, are generally known in the art. Non-limiting examples of such assays include immune-fluorescence staining using antibodies specifically binding to microbial structures and molecules, and subsequent visualization by fluorescence microscopy.

In some embodiments of the present invention, the augmented medium is configured to reduce the biochemical oxygen demand of water purified by the augmented medium by comparison to the biochemical oxygen demand of unpurified water.

In some embodiments of the present invention, the biochemical oxygen demand of water purified by the augmented medium is reduced by about 10%, 20%, 30%, 40%, 50%, 60%, 70%, 80%, 90% or 100% by comparison to the biochemical oxygen demand of unpurified water.

In some embodiments of the present invention the biochemical oxygen demand of water purified by the augmented medium is reduced by about 10 to 30%, 30 to 50%, 50 to 70%, or 70 to 100% by comparison to the biochemical oxygen demand of unpurified water.

MOCP is a cationic protein can therefore be electrostatically adsorbed onto different anionic surfaces. In some embodiments, this is shown by binding crude extract of Moringa oleifera seeds to sand, rice husks, and activated-carbon, and other filter media, such as iron oxide nanoparticles. Jerri et al., Langmuir 28:2262-2268 (2011); Barajas & Pagsuyoin, IEEE Systems and Information Engineering Design Symposium (2015), 2015; Santos et al., Environmental Science and Pollution Research 23:7692-7700 (2016).

After using an extraction process which yields the coagulation proteins from the Moringa oleifera seeds, MOCP adsorbs onto activated carbon and rice husk, functionalizing the media to increase their ability to disinfect and destabilize bacteria in contaminated water. Jerri et al., Langmuir 28:2262-2268 (2011); Barajas & Pagsuyoin, IEEE Systems and Information Engineering Design Symposium (2015); Kansal & Kumari, Chemical Reviews 114:4993-5010 (2014).

The Moringa oleifera-augmented surface is tightly bound to the surface of the adsorbent and will not leach into the solution. Jerri et al., Langmuir 28:2262-2268 (2011).

The filter media is incubated with purified MOCP such that it is coated with MOCP and with no other organic matter. The details of an exemplary purification process are shown in FIG. 7. The desalting step, while not recommended for the coagulant by Ghebremichael et al., is necessary here so that the ionic strength of the MOCP solution is low enough so that the MOCP may attach to the filter media electrostatically.

For a stronger bond between MOCP and filter media, one or more chemicals may be added to the MOCP solution that will bind it chemically to the filter media. Non-limiting examples of such chemicals that may be used in the context of the present invention are disclosed in Kwaambwa et al., Langmuir 26: 3902-3910 (2010), which is incorporated herein by reference in its entirety.

In some embodiments of the present invention, the protein-binding process comprises obtaining the MOCP solution obtained from the extraction and purification process, and submerging the filter media in the aqueous solution. The filter media and the solution are then agitated or mixed, allowing the cationic protein to bind to the surface of filter media. An illustration of this exemplary process is depicted in FIG. 7.

To avoid denaturation of MOCP during the course of its binding to filter media, the binding process should preferably be conducted at a temperature that is below the temperature at which MOCP denatures, which is approximately 100° C., and the use of chemicals that denature this protein should be avoided.

The invention includes adsorption methods to prevent denaturation of the MOCP, which include, as a non-limiting example, the adsorption at a temperature below the temperature at which MOCP typically denatures. In a preferred embodiment, the medium is treated with MOCP after the medium was fired.

In a preferred embodiment, the carbon media are activated via a method that does not result in a chemical reaction of the MOCP and does not denature it or break it down. Non-limiting exemplary methods in the context of the present invention include the use of media that have not been chemically activated, thereby preventing the carry-over of reagents harmful to MOCP.

### Water Filters

The present invention provides a water filter, including the augmented medium for water purification described herein.

The present invention provides a water filtration device, including at least an upper chamber and a lower chamber separated by at least one filter, wherein said filter is positioned to filter water as it passes from said upper chamber to said lower, and wherein the filter includes the augmented medium for water purification disclosed herein.

The present invention provides a water filtration device, including at least an upper chamber and a lower chamber separated by at least one filter, wherein said filter is positioned to filter water as it passes from said upper chamber to said lower, and wherein the filter comprises means for purifying the water and means for substantially inhibiting bacterial growth.

According to some embodiments, Moringa oleifera activated carbon can be used within a point-of-use household water filter. But the present invention is not limited to such embodiments.

Water filters of various configurations are generally known in the art and disclosed for example in U.S. Pat. Nos. 6,227,382; 6,254,768; 6,405,875 and 6,841,067, which are incorporated herein by reference in their entireties. In some embodiments of the present invention, the water filter of the present invention is configured to be gravity-fed. Gravity-fed water filters in general are widely known in the art, and disclosed for example in the same patents.

The present invention provides a method of purifying water, including treating water with the water filter disclosed herein.

The present invention provides a method of inactivating bacteria in water, including treating water with the water filter disclosed herein.

In some embodiments of the present invention, water is treated with the augmented medium for water purification by bringing it in contact with the augmented medium for a certain period of time. In some embodiments of the present invention, water is treated with the augmented medium for water purification by pouring the water into a water filtration device, including at least an upper chamber and a lower chamber separated by at least one filter, wherein said filter is positioned to filter water as it passes from said upper chamber to said lower, and wherein the filter includes means for purifying the water and means for substantially preventing bacterial growth.

In some embodiments of the present invention, the biochemical oxygen demand (BOD) of the water purified by the methods of the present invention is reduced by comparison to the BOD of the unpurified water. In some embodiments of the present invention, the BOD is reduced by about 10%, 20%, 30%, 40%, 50%, 60%, 70%, 80%, 90%, 100%, 120%, 150%, 200% or 500%. In some embodiments of the present invention, the BOD is reduced by 10% to 100%, 100% to 200%, or 200% to 500%.

BOD may be determined by the method described in Jerri et al., Langmuir 28:2262-2268 (2011), which is incorporated herein by reference in its entirety. Preferrably, BOD is determined using a BODTrak II™ device from Hach®, Loveland, Colo., according to the manufacturer's suggestions.

All references cited in this application are incorporated herein by reference in their entirety.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make these and other modifications and variations to that disclosed herein without departing from the scope of any claims.

### EXAMPLES

### Example 1

Our experiments have shown that the use of crude (i.e., non-purified) Moringa oleifera protein extract in connection with activated carbon and F-sand results in undesired increase of bacterial growth.
1. Carbon (MAC) Filter Treated With Crude Moringa oleifera Protein Extract

Crude Moringa oleifera protein extract was created using the following process:

1. Crushing Moringa oleifera seeds and grinding them into powder
2. Mixing them with distilled water at a ratio of 10 g of seed to 1 L of water for 5 minutes
3. Filtering the serum to 0.2 microns

Extract was mixed immediately with the desired media. Three sample filters were made:

1. Activated carbon control (ACC): carbon not treated with crude Moringa oleifera protein extract
2. Activated carbon 1 (AC1): carbon treated with crude Moringa oleifera protein extract
3. F-sand control (FSC): silica sand treated with crude Moringa oleifera protein extract

All media were washed in distilled water 5 times at a volume ratio of 1:5 media to water. AC1 and FSC were made both with 1 liter of crude extract using the following steps:

1. Combine the crude Moringa oleifera protein extract with the media and mix at 80 rpm for 5 minutes
2. Wash the media with distilled water and decant wash water, repeat 5 times

The filter components were:

1. PVC pipe with end caps Nominal Bore 1″, OD 33.40 mm, Schedule STD, ID 26.64 mm
2. Stainless Steel 80 mesh screen
3. White 100% silicone caulk to seal the screen in place and seal the cap to the pipe
4. ½ clear vinyl pipe
5. 3″ PVC end cap as a influent receptacle
6. Ring stand and clamps to hold filter and receptacle
7. Brass nipples and junctions to connect receptacle together with filter

The influent was taken from the Schuylkill River in Philadelphia and run through each filter one-at-a-time. The performance of each filter as well as the control can be seen in the following Table 1:

TABLE 1

| | Total volume | Coliform | | E. coli | |
|---|---|---|---|---|---|
| Sample | filtered | cfu/100 | Coliform | cfu/100 | E. coli |
| Name | [mL] | mL | LRV | mL | LRV |
| Control | N/A | 9606 | | 1317 | |
| FSC | 250 | 6586 | 0.2 | 1081 | 0.1 |
| ACC | 250 | 9139 | 0.0 | 816 | 0.2 |
| AC1 | 250 | 10112 | −0.1 | 1019 | 0.1 |

The units of the bacterial measurement are Most Probable Number (MPN) per 100 mL. MPN refers to the statistical method of determining how many colony forming units are in a given sample.

First, no filter achieved a sizeable reduction in bacteria on the log scale in any case because of quick saturation. Second, the carbon filter treated with crude Moringa oleifera protein extract is the only sample to increase the coliform count. This increase was created by the extra organic matter present in the crude extract that is not present in the purified extract. Used in the intended source of water, concentrations of bacteria or orders of magnitude lower, thus enabling MOCP to prevent growth of bacteria on the filter media over time when purified MOCP is used instead of the crude Moringa oleifera extract.
2. Sand Filters Treated With Crude Moringa oleifera Protein Extract

The filter components were:

1. PVC pipe with cap: Nominal Bore 1.5″, OD 48.3 mm, Schedule STD, ID 40.9 mm
2. 50-70 mesh silica sand
3. Stainless Steel 80 mesh screen
4. ½ clear vinyl pipe
5. 3″ PVC end cap as a influent receptacle
6. Ring stand and clamps to hold filter and receptacle
7. Brass nipples and junctions to connect receptacle together with filter
8. White 100% silicone caulk to hold the screen in place and seal the junctions

The pipe was cut to 12 in, leaving about 2 in of room above the sand. Sand was measured by mass and placed into the filters. Distilled water was used for the entire process.

Sand treated with Moringa oleifera crude extract was created using the following process:

1. Crushing the seeds and grinding them into powder
2. Mixing them with distilled water at a ratio of 10 g of seed to 1 L of water for 5 minutes
3. Pushing the serum through a filter
4. Combine the serum with the silica sand and mix at 80 rpm for 5 minutes at a ratio of 1 L of crude extract to 100 g of sand
5. Wash the sand with distilled water and decant wash water, repeat 4 times

The sand for the sand filter was also washed using the same process. One filter was filled with sand treated with crude Moringa oleifera extract (labeled M Case), and the other was sand (labeled Sand Case). The influent was taken from the Schuylkill River in Philadelphia and run through each filter one-at-a-time. The performance of each filter can be seen in the following Table 2:

TABLE 2

| | Total volume | Coliform | | E. coli | |
|---|---|---|---|---|---|
| Sample | filtered | cfu/100 | Coliform | cfu/100 | E. coli |
| Name | [mL] | mL | LRV | mL | LRV |
| Control | N/A | 36090 | | 2920 | |
| Sand Case 1 | 250 | 1455 | 1.4 | 850 | 0.5 |
| Sand Case 2 | 500 | 57940 | −0.2 | 2490 | 0.1 |
| Sand Case 3 | 750 | 43520 | −0.1 | 2160 | 0.1 |
| M Case 1 | 250 | 1616 | 1.3 | 41 | 1.9 |
| M Case 2 | 500 | 6294 | 0.8 | 402 | 0.9 |
| M Case 3 | 750 | 24196 | 0.2 | 798 | 0.6 |

The results of this test show that sand treated with crude Moringa oleifera extract, while it does decrease the concentration of bacteria, becomes saturated within the first liter of filtering a highly contaminated source. This test shows that by scaling up the use of sand media treated with crude Moringa oleifera extract, we obtain results that are not effective for our invention.

### Example 2

There are two basic approaches for activating carbon. In the first approach, carbon is activated with heat (preferably above 200° C.; by using steam for example), and in the second approach, carbon is activated chemically.

A common chemical used for chemical activation is sodium hydroxide (NaOH). NaOH is known to cause protein denaturation. Since carbon activated with NaOH contains residual NaOH after activation, a protein that comes in contact with the NaOH-activated carbon may become denatured.

Crude protein extracts from Moringa oleifera seeds were made by using the following process:

(1) Crush the seeds and grind them into powder.

(2) Mix them with distilled water at a ratio of 10 g of seed to 1 L of water for 5 minutes.

(3) Filter the serum to 0.2 microns.

Standard carbon media were activated with steam or NaOH, in accordance with standard procedures generally known in the art. After activation, the carbon media were washed in distilled water 5 times at a volume ratio of 1:5 media to water.

The crude extracts were then mixed immediately with the activated carbon media by using the following process:

(1) Combine the crude extract with the media at a ratio of 70 mL of media to 1 L of extract and mix at 80 rpm for 5 minutes

(2) Wash the media with distilled water and decant wash water, repeat 5 times

Controls included media not treated with the crude extracts. Another control was included wherein the sample activated with steam was heated to about 200° C. after treatment with the crude extract.

The activity of the Moringa oleifera crude extract used for treating the media was determined as follows.

(1) Place granular activated carbon media treated with Moringa oleifera crude extract into a PET container.

(2) Fill the container with distilled water until the media is completely submerged.

(3) Turn the container sideways such that its central axis is perpendicular to gravity.

(4) With the filter media approximately evenly distributed along the side of the container, roll the container at 10-20 rpm through at least one full resolution.

(5) Repeat steps 2-4 with non-treated carbon media and with treated carbon media subjected to an additional steam heating step at about 200° C. after the treatment with the crude extract.

The results of these experiments are summarized in the Table 3 below. A positive result indicates that the media adhered to the PET plastic container. A negative result indicated that the media did not adhere to the PET plastic container. The term “Moringa” in Table 3 indicates that samples were treated with Moringa oleifera crude extract.

TABLE 3

| Sample | Result |
|---|---|
| Steam-activated carbon | Negative |
| Moringa steam-activated carbon before heat treatment | Positive |
| Moringa steam-activated carbon after heat treatment | Negative |
| Chemically-activated carbon | Negative |
| Moringa chemically-activated carbon | Positive |

Due to the cationic nature of MOCP and the anionic nature of the PET plastic, the media treated with Moringa oleifera crude extract formed a film along the inside walls of the container. Media not treated with Moringa oleifera crude extract and media treated with Moringa oleifera crude extract wherein MOCP had lost its cationic character because it had been subsequently denatured exhibited only minimal electrostatic attraction to the PET plastic container and thus did not form a film along the inside walls of the container.

The results in Table 3 show that both heat and NaOH activated carbon are suitable for treatment with crude Moringa oleifera extract. The results also show that heat (about 200° C.) treatment after activated carbon is treated with crude Moringa oleifera protein extract denatures MOCP and thus interferes with its function (i.e., cationic nature).

### Example 3

To obtain Moringa oleifera coagulant protein (MOCP), seeds of Moringa oleifera are first harvested and the oil is extracted from the seeds using a standard physical press. The resulting cake is then ground and powderized. The powder is then dissolved in an aqueous solution of sodium chloride, and the soluble fraction, which includes MOCP, is further purified by ion-exchange chromatography, according to Protein Purification-Principles, High Resolution methods, and Applications Vol. 54, J.-C. Janson ed., Wiley (2011). The resulting aqueous solution containing MOCP is then used to treat the heat-activated carbon medium.

What is claimed is:

1. An augmented medium for water purification, comprising a medium selected from the group consisting of ceramic, granular activated carbon, resin, and carbon blocks, or a combination thereof; and purified Moringa oleifera coagulant protein (MOCP).

2. The augmented medium for water purification of claim 1, wherein the Moringa oleifera coagulant protein is adsorbed to the medium.

2. The augmented medium for water purification of claim 1, wherein the medium is ceramic.

3. The augmented medium for water purification of claim 1, wherein the medium is granular activated carbon.

4. The augmented medium for water purification of claim 1, wherein the medium is resin.

5. The augmented medium for water purification of claim 1, wherein the medium is carbon blocks.

6. The augmented medium for water purification of claim 1, wherein Moringa oleifera coagulant protein is adsorbed to the surface of the medium.

7. The augmented medium for water purification of claim 1, consisting essentially of a medium selected from the group consisting of ceramic, granular activated carbon, resin, and carbon blocks, or a combination thereof; and purified Moringa oleifera coagulant protein.

8. The augmented medium for water purification of claim 1, wherein the purified Moringa oleifera coagulant protein is prepared by a process comprising steps of (1) treating a Moringa oleifera seed press cake to obtain an evenly divided granular powder, (2) adding the granular powder to an aqueous salt solution or water, thereby eluting Moringa oleifera coagulant protein out of the powder, and (3) purifying the Moringa oleifera coagulant protein obtained in step 2 by one or a combination of dialysis, delipidation, centrifugation and ion exchange chromatography.

9. The augmented medium for water purification of claim 8, wherein the purified Moringa oleifera coagulant protein is bound to the medium by a process comprising steps of (1) obtaining the Moringa oleifera coagulant protein purified by one or a combination of dialysis, dilapidation, centrifugation and ion exchange chromatography, (2) creating an aqueous solution of the protein of the preceding step, and (3) treating the medium with the aqueous solution.

10. The augmented medium for water purification of claim 9, wherein the carbon medium is activated by physical activation or by chemical activation.

11. The augmented medium for water purification of claim 9, wherein the aqueous solution with which the medium is treated is substantially free of proteins other than Moringa oleifera coagulant protein.

12. The augmented medium for water purification of claim 11, wherein the aqueous solution with which the medium is treated is substantially free of lipids, carbohydrates, nucleic acids, and proteins other than Moringa oleifera coagulant protein.

13. The augmented medium for water purification of claim 12, wherein the aqueous solution with which the medium is treated is substantially free of organic molecules other than Moringa oleifera coagulant protein.

14. The augmented medium for water purification of claim 1, wherein the augmented medium is configured to inhibit growth of microorganisms on the media surfaces.

15. The augmented medium for water purification of claim 1, wherein the augmented medium is configured to reduce the biochemical oxygen demand of water purified by the augmented medium by comparison to the biochemical oxygen demand of unpurified water.

16. The augmented medium for water purification of claim 15, wherein the biochemical oxygen demand is reduced by about 100%.

17. A method of making an augmented medium for water purification, comprising steps of (1) treating a Moringa oleifera seed press cake to obtain an evenly divided granular powder, (2) adding the granular powder to an aqueous salt solution or water, thereby eluting Moringa oleifera coagulant protein (MOCP) out of the powder, (3) purifying the Moringa oleifera coagulant protein obtained in step 2 by one or a combination of dialysis, dilapidation, centrifugation and ion exchange chromatography, (4) creating an aqueous solution of the Moringa oleifera coagulant protein of the preceding step, and (4) treating the medium with the aqueous solution, wherein the purified Moringa oleifera coagulant protein is adsorbed to the medium.

18. The method of making an augmented medium for water purification of claim 17, wherein the medium is selected from the group consisting of ceramic, granular activated carbon, resin, and carbon blocks.

19. The method of making an augmented medium for water purification of claim 18, wherein the medium is carbon that is activated by physical activation or by chemical activation.

20. A water filter, comprising the augmented medium for water purification of claim 1.

21. The water filter of claim 20, wherein the water filter is configured to be gravity-fed.

22. The water filter of claim 21, comprising at least an upper chamber and a lower chamber separated by at least one filter, wherein said filter is positioned to filter water as it passes from said upper chamber to said lower chamber, and wherein the filter comprises the augmented medium for water purification of claim 1.

22. A water filtration device, comprising at least an upper chamber and a lower chamber separated by at least one filter, wherein said filter is positioned to filter water as it passes from said upper chamber to said lower, and wherein the filter comprises means for purifying the water and means for substantially inhibiting bacterial growth.

23. A method of purifying water, comprising treating water with the water filter of claim 20.

24. A method of inactivating bacteria in water, comprising treating water with the water filter of claim 20.
